(19) United States
(12) Patent Application Publication
(10) Pub. No.: US 2024/0186708 A1
(43) Pub. Date: Jun. 6, 2024

(54) ANTENNA AND ELECTRONIC APPARATUS

(71) Applicants: Beijing BOE Technology Development Co., Ltd., Beijing (CN); BOE Technology Group Co., Ltd., Beijing (CN)

(72) Inventors: Liang Guo, Beijing (CN); He Liu, Beijing (CN); Feng Qu, Beijing (CN); Guoqiang Tang, Beijing (CN); Yali Wang, Beijing (CN)

(73) Assignees: Beijing BOE Technology Development Co., Ltd., Beijing (CN); BOE Technology Group Co., Ltd., Beijing (CN)

(21) Appl. No.: 17/760,271

(22) PCT Filed: Dec. 22, 2021
(86) PCT No.: PCT/CN2021/140356

§ 371 Date: Aug. 5, 2022

(51) Int. Cl. H01Q 9/06; H01Q 1/36; H01Q 9/04

(52) U.S. Cl. CPC H01Q 9/065; H01Q 1/36; H01Q 9/045

(57) ABSTRACT

An antenna is provided. The antenna includes a ground plate; a dielectric layer on the ground plate; and a radiating patch and a microstrip feed line on a side of the dielectric layer away from the ground plate. The radiating patch has a parallelogram shape having a first side connected to the microstrip feed line, a second side opposite to the first side, a third side connecting the first side and the second side, and a fourth side converting the first side and the second side, the third side being opposite to the fourth side. The antenna further includes a gain enhancement structure on at least one of the second side, the third side, or the fourth side.

### TECHNICAL FIELD

The present invention relates to an antenna and an electronic apparatus.

### BACKGROUND

In related art, a magnetic dipole antenna includes a loop antenna that radiates electromagnetic waves in response to current circulating through the loop. The antenna contains one or more elements. Elements are the conductive parts of an antenna system that determine the antenna's electromagnetic characteristics. The element of a magnetic dipole antenna is designed so that it resonates at a predetermined frequency as required by the application for which it is being used.

### SUMMARY

In one aspect, the present disclosure provides an antenna, comprising a ground plate; a dielectric layer on the ground plate; and a radiating patch and a microstrip feed line on a side of the dielectric layer away from the ground plate; wherein the radiating patch has a parallelogram shape having a first side connected to the microstrip feed line, a second side opposite to the first side, a third side connecting the first side and the second side, and a fourth side connecting the first side and the second side, the third side being opposite to the fourth side; and the antenna further comprises a gain enhancement structure on at least one of the second side, the third side, or the fourth side.

Optionally, the gain enhancement structure is on each of the second side, the third side, and the fourth side.

Optionally, a structure comprising the radiating patch and the microstrip feed line has a mirror symmetry with respect to a plane perpendicular to a surface of the ground plate, and passing through a center line intersecting a center point of the microstrip feed line and a center point of the radiating patch.

Optionally, the gain enhancement structure is configured to produce one or more standing waves in a peripheral area on the first side of the radiating patch due to increased current distribution therein.

Optionally, the gain enhancement structure is configured to produce increased current distribution in at least a portion of a peripheral area on the first side of the radiating patch, relative to current distribution in at least a portion of a central area of the radiating patch.

Optionally, the gain enhancement structure comprises a plurality of teeth connected to and extending away from the second side, the third side, and the fourth side of the radiating patch, respectively.

Optionally, on each of the second side, the third side, and the fourth side of the radiating patch, multiple teeth are spaced apart by multiple slits, respectively; the multiple teeth are equispaced; and the multiple slits are equispaced.

Optionally, a respective teeth of the multiple teeth has a first width along a direction across the multiple teeth and the multiple slits; a respective slit of the multiple slits has a second width along the direction across the multiple teeth and the multiple slits; and a ratio of the first width to the second width is in a range of 1:2 to 2:1.

Optionally, a respective teeth of the multiple teeth has a first width along a direction across the multiple teeth and the multiple slits in a range of 1 mm to 4 mm.

Optionally, a respective slit of the multiple slits has a second width along a direction across the multiple teeth and the multiple slits in a range of 2 mm to 6 mm.

Optionally, the plurality of teeth are configured to produce increased current distribution in at least a portion of a peripheral area on the first side of the radiating patch and in at least portions of the plurality of teeth, relative to current distribution in at least a portion of a central area of the radiating patch.

Optionally, a ratio of a number of teeth on the second side to a number of teeth on the third side or to a number of teeth on the fourth side is in a range of 5:1 to 25:1.

Optionally, a ratio of a width of the second side to a width of the third side or to a width of the fourth side is in a range of 5:1 to 20:1.

Optionally, the gain enhancement structure comprises shorting walls connecting the second side, the third side, and the fourth side of the radiating patch respectively to the ground plate.

Optionally, the dielectric layer comprises air.

Optionally, the dielectric layer comprises a lossy dielectric material.

Optionally, the antenna further comprises an impedance transformation line configured to perform impedance matching; wherein the impedance transformation line connects the microstrip feed line to the radiating patch.

Optionally, the antenna is configured to be a magnetic dipole antenna.

Optionally, the gain enhancement structure is absent on the first side.

In another aspect, the present disclosure provides an electronic apparatus, comprising the antenna described herein.

### BRIEF DESCRIPTION OF THE FIGURES

The following drawings are merely examples for illustrative purposes according to various disclosed embodiments and are not intended to limit the scope of the present invention.

FIG. 1A is a plan view of an antenna in some embodiments according to the present disclosure.

FIG. 1B illustrates the structure of a ground plate in an antenna depicted in FIG. 1A.

FIG. 1C illustrates the structure of a dielectric layer in an antenna depicted in FIG. 1A.

FIG. 1D illustrates the structure of a microstrip feed line and a radiating patch in an antenna depicted in FIG. 1A.

FIG. 2A is a cross-sectional view of an antenna in some embodiments according to the present disclosure.

FIG. 2B is a cross-sectional view along a B-B′ line in FIG. 1A.

FIG. 3A illustrates an S11 graph of the antenna depicted in FIG. 1A.

FIG. 3B illustrates a peak realized gain curve of the antenna depicted in FIG. 1A.

FIG. 3C illustrates current distribution in an antenna depicted in FIG. 1A.

FIG. 4A is a plan view of an antenna in some embodiments according to the present disclosure.

FIG. 4B illustrates the structure of a ground plate in an antenna depicted in FIG. 4A.

FIG. 4C illustrates the structure of a dielectric layer in an antenna depicted in FIG. 4A.

FIG. 4D illustrates the structure of a microstrip feed line and a radiating patch in an antenna depicted in FIG. 4A.

FIG. 5 is a cross-sectional view of an antenna in some embodiments according to the present disclosure.

FIG. 6A illustrates an S11 graph of the antenna depicted in FIG. 4A.

FIG. 6B illustrates a peak realized gain curve of the antenna depicted in FIG. 4A.

FIG. 6C illustrates current distribution in an antenna depicted in FIG. 4A.

FIG. 7A is a plan view of an antenna in some embodiments according to the present disclosure.

FIG. 7B illustrates the structure of a ground plate in an antenna depicted in FIG. 7A.

FIG. 7C illustrates the structure of a dielectric layer in an antenna depicted in FIG. 7A.

FIG. 7D illustrates the structure of a microstrip feed line and a radiating patch in an antenna depicted in FIG. 7A.

FIG. 8 is a cross-sectional view along a E-E′ line in FIG. 7A.

FIG. 9A illustrates an S11 graph of the antenna depicted in FIG. 7A.

FIG. 9B illustrates a peak realized gain curve of the antenna depicted in FIG. 7A.

FIG. 9C illustrates current distribution in an antenna depicted in FIG. 7A.

FIG. 10 is a plan view of an antenna in some embodiments according to the present disclosure.

FIG. 11A illustrates an S11 graph of the antenna depicted in FIG. 10.

FIG. 11B illustrates a peak realized gain curve of the antenna depicted in FIG. 10.

FIG. 11C illustrates current distribution in an antenna depicted in FIG. 10.

FIG. 12A is a plan view of an antenna in some embodiments according to the present disclosure.

FIG. 12B illustrates the structure of a ground plate in an antenna depicted in FIG. 12A.

FIG. 12C illustrates the structure of a dielectric layer in an antenna depicted in FIG. 12A.

FIG. 12D illustrates the structure of a microstrip feed line and a radiating patch in an antenna depicted in FIG. 12A.

FIG. 13 is a cross-sectional view along an F-F′ line in FIG. 12A.

FIG. 14A illustrates an S11 graph of the antenna depicted in FIG. 12A.

FIG. 14B illustrates a peak realized gain curve of the antenna depicted in FIG. 12A.

FIG. 14C illustrates current distribution in an antenna depicted in FIG. 12A.

FIG. 15A is a plan view of an antenna in some embodiments according to the present disclosure.

FIG. 15B illustrates the structure of a ground plate in an antenna depicted in FIG. 15A.

FIG. 15C illustrates the structure of a dielectric layer in an antenna depicted in FIG. 15A.

FIG. 15D illustrates the structure of a microstrip feed line and a radiating patch in an antenna depicted in FIG. 15A.

FIG. 16 is a cross-sectional view along a G-G′ line in FIG. 15A.

FIG. 17A illustrates an S11 graph of the antenna depicted in FIG. 15A.

FIG. 17B illustrates a peak realized gain curve of the antenna depicted in FIG. 15A.

FIG. 17C illustrates current distribution in an antenna depicted in FIG. 15A.

FIG. 18A is a plan view of an antenna in some embodiments according to the present disclosure.

FIG. 18B illustrates the structure of a ground plate in an antenna depicted in FIG. 18A.

FIG. 18C illustrates the structure of a dielectric layer in an antenna depicted in FIG. 18A.

FIG. 18D illustrates the structure of a microstrip feed line and a radiating patch in an antenna depicted in FIG. 18A.

FIG. 19 is a cross-sectional view along an H-H′ line in FIG. 18A.

FIG. 20A illustrates an S11 graph of the antenna depicted in FIG. 18A.

FIG. 20B illustrates a peak realized gain curve of the antenna depicted in FIG. 18A.

FIG. 20C illustrates current distribution in an antenna depicted in FIG. 18A.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, an antenna and an electronic apparatus that substantially obviate one or more of the problems due to limitations and disadvantages of the related art. In one aspect, the present disclosure provides an antenna. In some embodiments, the antenna includes a ground plate, a dielectric layer on the ground plate; and a radiating patch and a microstrip feed line on a side of the dielectric layer away from the ground plate. Optionally, the radiating patch has a parallelogram shape having a first side connected to the microstrip feed line, a second side opposite to the first side, a third side connecting the first side and the second side, and a fourth side connecting the first side and the second side, the third side being opposite to the fourth side. Optionally, the antenna further includes a gain enhancement structure on at least one of the second side, the third side, or the fourth side.

The inventors of the present disclosure, surprisingly and unexpectedly, discover that, by having the gain enhancement structure according to the present disclosure on at least one of the second side, the third side, or the fourth side, the antenna according to the present disclosure can effectively function as a magnetic dipole antenna. As discussed in detail below, in the present antenna, radiation of the antenna is concentrated on a side where the microstrip feed line is connected. The side of the radiating patch having the microstrip feed line functions as a magnetic current source.

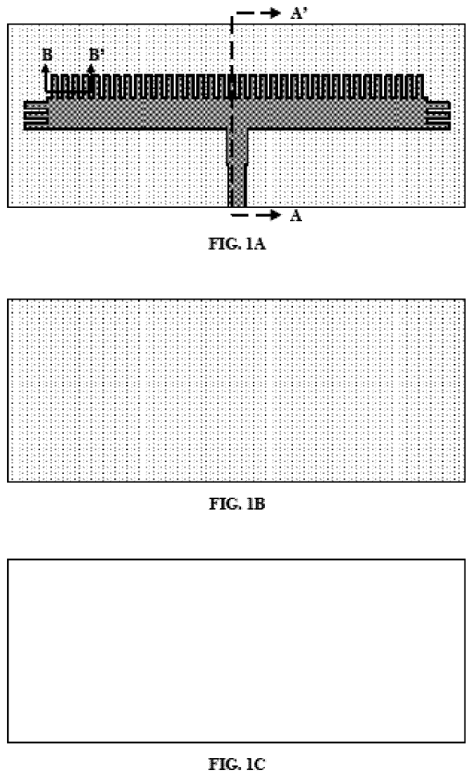

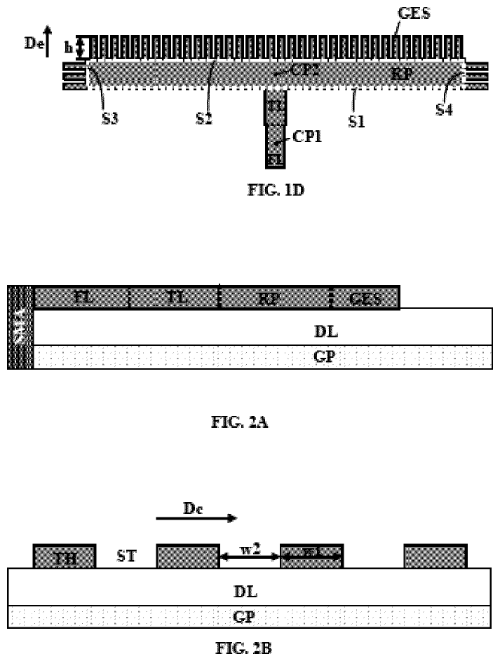

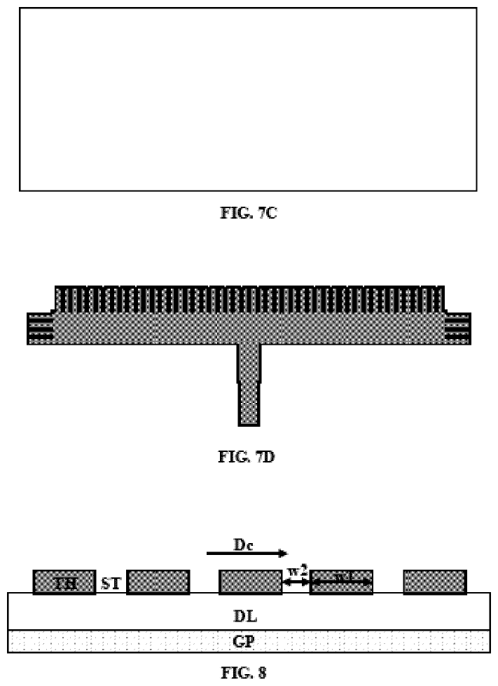

FIG. 1A is a plan view of an antenna in some embodiments according to the present disclosure. FIG. 1B illustrates the structure of a ground plate in an antenna depicted in FIG. 1A. FIG. 1C illustrates the structure of a dielectric layer in an antenna depicted in FIG. 1A. FIG. 1D illustrates the structure of a microstrip feed line and a radiating patch in an antenna depicted in FIG. 1A. FIG. 2A is a cross-sectional view of an antenna in some embodiments according to the present disclosure, for example, along an A-A′ line in FIG. 1A, along a D-D′ line in FIG. 7A. Referring to FIG. 1A to FIG. 1D, and FIG. 2A, the antenna in some embodiments includes a ground plate GP, a dielectric layer DL on the ground plate GP; and a radiating patch RP and a microstrip feed line FL on a side of the dielectric layer DL away from the ground plate GP.

In some embodiments, the radiating patch RP has a parallelogram shape having a first side S1 connected to the microstrip feed line FL, a second side S2 opposite to the first side S1, a third side S3 connecting the first side S1 and the second side S2, and a fourth side S4 connecting the first side S1 and the second side S2, the third side S3 being opposite to the fourth side S4.

Various appropriate parallelogram shapes may be implemented in the present radiating patches. Optionally, the parallelogram shape is a rectangular shape. Optionally, the parallelogram shape is a square shape.

In some embodiments, the antenna further includes a gain enhancement structure GES on at least one of the second side S2, the third side S3, or the fourth side S4. Referring to FIG. 1A to FIG. 1D, in some embodiments, the gain enhancement structure GES includes a plurality of teeth connected to and extending away from the second side S2, the third side S3, and the fourth side S4 of the radiating patch RP, respectively. Accordingly, in some embodiments, the gain enhancement structure GES is on each of the second side S2, the third side S3, and the fourth side S4.

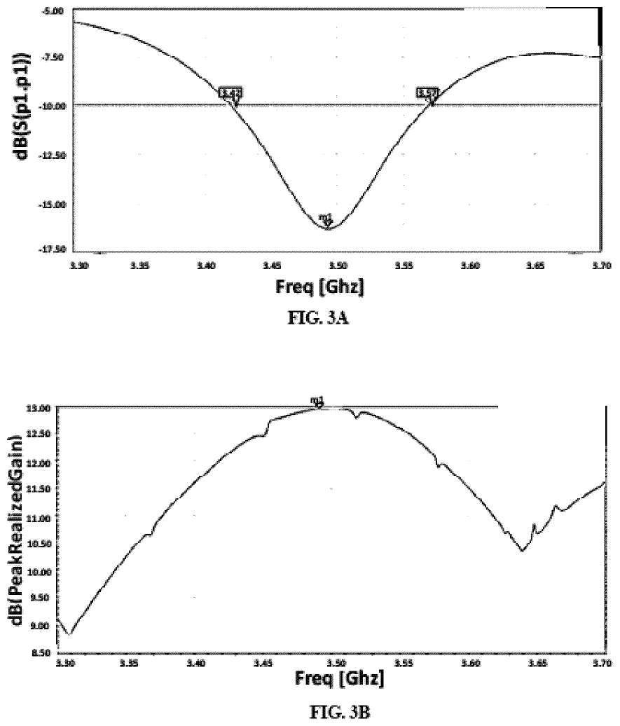

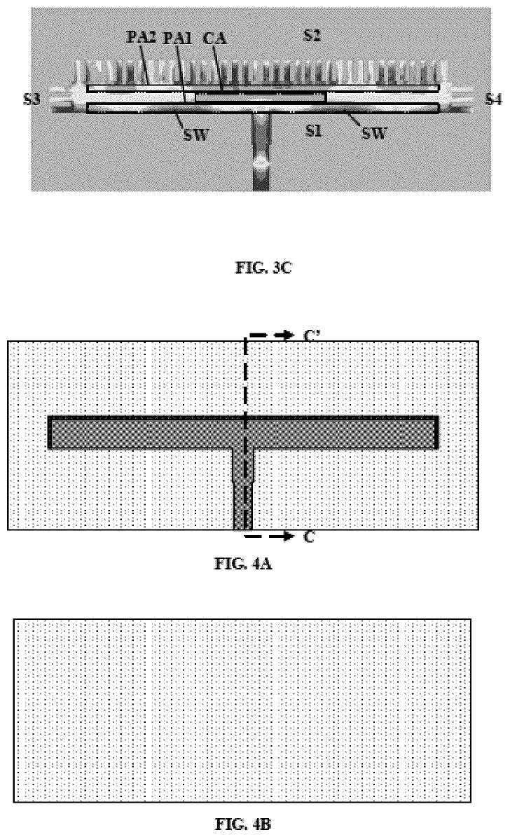

FIG. 3A illustrates an S11 graph of the antenna depicted in FIG. 1A. FIG. 3B illustrates a peak realized gain curve of the antenna depicted in FIG. 1A. In one specific example, the antenna has an overall thickness of 0.05 λ₀, wherein λ₀ stands for a wavelength in vacuum of a radiation produced by the antenna. The dielectric layer includes a lossless dielectric material, e.g., the dielectric layer is an air layer. Referring to FIG. 3A, the antenna has a −10 dB impedance bandwidth of 150 MHz (ranging from 3.42 GHz to 3.57 GHz). Referring to FIG. 3B, the peak value of gain is 12.95 dBi. The bandwidth of the antenna substantially covers the n78 band, which ranges from 3.4 GHz to 3.6 GHz.

In some embodiments, referring to FIG. 1A to FIG. 1D, a structure including the radiating patch RP and the microstrip feed line FL has a mirror symmetry with respect to a plane perpendicular to a surface of the ground plate GP, and passing through a center line intersecting a center point of the microstrip feed line and a center point of the radiating patch (depicted as CP1 and CP2 in FIG. 1D).

FIG. 3C illustrates current distribution in an antenna depicted in FIG. 1A. Referring to FIG. 1D and FIG. 3C, in some embodiments, the gain enhancement structure GES is configured to produce one or more standing waves SW in a peripheral area on the first side S1 of the radiating patch RP due to increased current distribution therein. In some embodiments, the gain enhancement structure GSE is configured to produce increased current distribution in at least a portion of a peripheral area on the first side S1 of the radiating patch RP, relative to current distribution in at least a portion of a central area CA of the radiating patch RP. Moreover, when the gain enhancement structure GSE includes a plurality of teeth, the plurality of teeth are configured to produce increased current distribution in at least a portion of a peripheral area on the first side S1 of the radiating patch and in at least portions of the plurality of teeth, relative to current distribution in at least a portion of a central area CA of the radiating patch RP. Optionally, the gain enhancement structure GSE is configured to produce increased current distribution in at least a portion of a peripheral area on the first side S1 of the radiating patch RP, relative to current distribution in at least a portion of a peripheral area on the second side S2 of the radiating patch RP. The peripheral area on the first side S1 of the radiating patch RP is denoted as PA1 in FIG. 3C, and the peripheral area on the second side S2 of the radiating patch RP is denoted as PA2 in FIG. 3C. As shown in FIG. 1D and FIG. 3C, the presence of the gain enhancement structure GSE (e.g., the plurality of teeth) changes current distribution in the radiating patch RP, significantly enhancing radiation intensity of the radiating patch RP, and the gain of the antenna.

In some embodiments, on each of the second side S2, the third side S3, and the fourth side S4 of the radiating patch, multiple teeth are spaced apart by multiple slits, respectively. Optionally, the multiple teeth are equispaced. Optionally, the multiple slits are equispaced. In one example, the multiple teeth on the second side S2 are equispaced, and the multiple slits on the second side S2 are equispaced. In another example, the multiple teeth on the third side S3 are equispaced, and the multiple slits on the third side S3 are equispaced. In another example, the multiple teeth on the fourth side S4 are equispaced, and the multiple slits on the fourth side S4 are equispaced. As used herein, the term equispaced means the teeth or the slits are spaced at equal distances from each other.

FIG. 2B is a cross-sectional view along a B-B′ line in FIG. 1A. Referring to FIG. 2B, in some embodiments, a respective teeth TH of the multiple teeth has a first width w1 along a direction Dc across the multiple teeth and the multiple slits. A respective slit ST of the multiple slits has a second width w2 along the direction Dc across the multiple teeth and the multiple slits. Optionally, the first width w1 and the second width w2 are the same. Optionally, the first width w1 is greater than the second width w2. Optionally, the second width w2 is greater than the first width w1.

In some embodiments, a ratio of the first width w1 to the second width w2 is in a range of 1:2 to 2:1, e.g., 1:2 to 1:1.8, 1:1.8 to 1:1.6, 1:1.6 to 1:1.4, 1:1.4 to 1:1.2, 1:1.2 to 1:1, 1:1 to 1:1.2, 1:1.2 to 1:1.4, 1:1.4 to 1:1.6, 1:1.6 to 1:1.8, or 1:1.8 to 1:2. In one example depicted in FIG. 2B, the ratio of the first width w1 to the second width w2 is 1:1.

In some embodiments, the first width w1 is in a range of 1 mm to 4 mm, e.g., 1.0 mm to 1.5 mm, 1.5 mm to 2.0 mm, 2.0 mm to 2.5 mm, 2.5 mm to 3.0 mm, 3.0 mm to 3.5 mm, or 3.5 mm to 4.0 mm. In one example depicted in FIG. 2B, the first width w1 is 4.0 mm.

In some embodiments, the second width w2 is in a range of 2 mm to 6 mm, e.g., 2.0 mm to 2.5 mm, 2.5 mm to 3.0 mm, 2.0 mm to 2.5 mm, 2.5 mm to 3.0 mm, 4.0 mm to 4.5 mm, 4.5 mm to 5.0 mm, 5.0 mm to 5.5 mm, or 5.5 mm to 6.0 mm. In one example depicted in FIG. 2B, the second width w2 is 4.0 mm.

In some embodiments, referring to FIG. 1D and FIG. 2B, a respective teeth TH of the multiple teeth has a length h along a direction the respective teeth TH extending away from the radiating patch RP. Optionally, the length h is in a range of 10 mm to 30 mm, e.g., 10 mm to 15 mm, 15 mm to 20 mm, 20 mm to 25 mm, or 25 mm to 30 mm. In one example depicted in FIG. 1D, the length h is 17.5 mm.

The respective teeth and the respective slit may have various appropriate shapes. Examples of appropriate shapes include a parallelogram shape such as a rectangular shape and a square shape, a trapezoidal shape, an inverted trapezoidal shape, and a regular polygonal shape. In one example depicted in FIG. 1D, the respective teeth and the respective slit have a rectangular shape.

In some embodiments, a ratio of a width of the second side S2 to a width of the third side S3 or to a width of the fourth side S4 is in a range of 5:1 to 20:1, e.g., 5:1 to 6:1, 6:1 to 7:1, 7:1 to 8:1, 8:1 to 9:1, 9:1 to 10:1, 10:1 to 11:1, 11:1 to 12:1, 12:1 to 13:1, 13:1 to 14:1, 14:1 to 15:1, 15:1 to 16:1, 16:1 to 17:1, 17:1 to 18:1, 18:1 to 19:1, or 19:1 to 20:1. In one example depicted in FIG. 1D, the ratio of a width of the second side S2 to a width of the third side S3 or to a width of the fourth side S4 is 10.4:1.

In some embodiments, a ratio of a width of the first side S1 to a width of the third side S3 or to a width of the fourth side S4 is in a range of 5:1 to 20:1, e.g., 5:1 to 6:1, 6:1 to 7:1, 7:1 to 8:1, 8:1 to 9:1, 9:1 to 10:1, 10:1 to 11:1, 11:1 to 12:1, 12:1 to 13:1, 13:1 to 14:1, 14:1 to 15:1, 15:1 to 16:1, 16:1 to 17:1, 17:1 to 18:1, 18:1 to 19:1, or 19:1 to 20:1. In one example depicted in FIG. 1D, the ratio of a width of the first side S1 to a width of the third side S3 or to a width of the fourth side $4 is 10.4:1.

In some embodiments, a width of the first side S1 or the second side S2 is in a range of 150 mm to 350, e.g., 150 mm to 170 mm, 170 mm to 190 mm, 190 mm to 210 mm, 210 mm to 230 mm, 230 mm to 250 mm, 250 mm to 270 mm, 270 mm to 290 mm, 290 mm to 310 mm, 310 mm to 330 mm, or 330 mm to 350 mm. In one example depicted in FIG. 1D, the width of the first side S1 or the second side S2 is 260 mm.

In some embodiments, a width of the third side S3 or the fourth side S4 is in a range of 15 mm to 35 mm, e.g., 15 mm to 17 mm, 17 mm to 19 mm, 19 mm to 21 mm, 21 mm to 23 mm, 23 mm to 25 mm, 25 mm to 27 mm, 27 mm to 29 mm, 29 mm to 31 mm, 31 mm to 33 mm, or 33 mm to 35 mm. In one example depicted in FIG. 1D, the width of the third side S3 or the fourth side S4 is 25 mm.

In some embodiments, a ratio of a number of teeth on the second side S2 to a number of teeth on the third side S3 or to a number of teeth on the fourth side S4 is in a range of 5:1 to 25:1, e.g., 5:1 to 6:1, 6:1 to 7:1, 7:1 to 8:1, 8:1 to 9:1, 9:1 to 10:1, 10:1 to 11:1, 11:1 to 12:1, 12:1 to 13:1, 13:1 to 14:1, 14:1 to 15:1, 15:1 to 16:1, 16:1 to 17:1, 17:1 to 18:1, 18:1 to 19:1, 19:1 to 20:1, 20:1 to 21:1, 21:1 to 22:1, 22:1 to 23:1, 23:1 to 24:1, or 24:1 to 25:1. In one example depicted in FIG. 1D, the ratio of the number of teeth on the second side S2 to the number of teeth on the third side S3 or to the number of teeth on the fourth side S4 is 12:1. For example, the number of teeth on the second side S2 is 36, the number of teeth on the third side S3 is 3, and the number of teeth on the fourth side S4 is 3.

In some embodiments, the plurality of teeth are absent on the first side S1.

The inventors of the present disclosure, surprisingly and unexpectedly, discover that, by having the gain enhancement structure according to the present disclosure on at least one of the second side, the third side, or the fourth side, the antenna according to the present disclosure can effectively function as a magnetic dipole antenna. As shown in FIG. 3C, in the present antenna, radiation of the antenna is concentrated at least on a side where the microstrip feed line is connected. The side of the radiating patch having the microstrip feed line functions as a magnetic current source. As shown in FIG. 3C, at least portions of the plurality of teeth have increased current distribution. Thus, each teeth is equivalent to a monopole antenna. The antenna as a whole is equivalent a combination of an array of monopole antennae and a magnetic dipole antenna, resulting in a significantly increased gain (see, e.g., FIG. 3B).

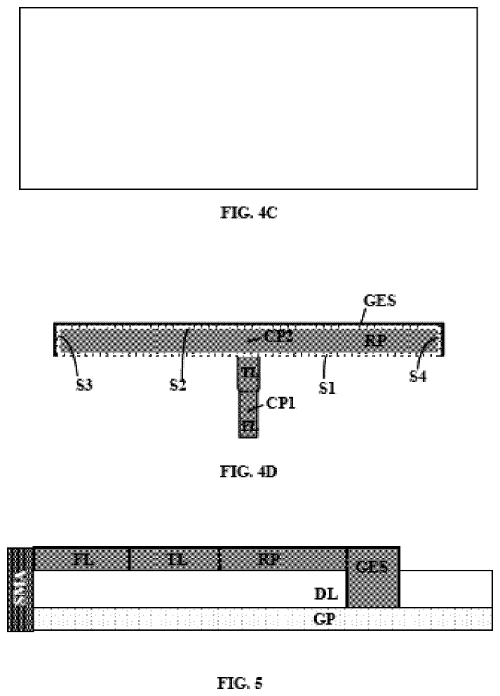

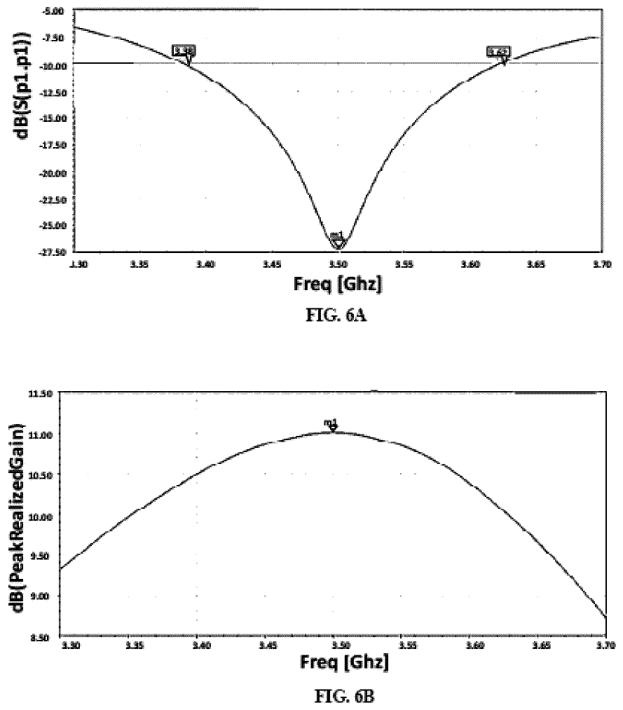

FIG. 4A is a plan view of an antenna in some embodiments according to the present disclosure. FIG. 4B illustrates the structure of a ground plate in an antenna depicted in FIG. 4A. FIG. 4C illustrates the structure of a dielectric layer in an antenna depicted in FIG. 4A. FIG. 4D illustrates the structure of a microstrip feed line and a radiating patch in an antenna depicted in FIG. 4A. FIG. 5 is a cross-sectional view of an antenna in some embodiments according to the present disclosure. Referring to FIG. 4A to FIG. 4D, and FIG. 5, the gain enhancement structure GES in some embodiments includes shorting walls connecting the second side S2, the third side S3, and the fourth side S4 of the radiating patch RP respectively to the ground plate GP. A respective shorting wall extends through the dielectric layer DL, connecting to the ground plate GP. For example, a first shorting wall connects the second side S2 of the radiating patch RP to the ground plate GP, a second shorting wall connects the third side S3 of the radiating patch RP to the ground plate GP, and a third shorting wall connects the fourth side S4 of the radiating patch RP to the ground plate GP. In one specific example depicted in FIG. 4A to FIG. 4D, the first shorting wall, the second shorting wall, and the third shorting wall are parts of a unitary structure. As shown in FIG. 4A to FIG. 4D, and FIG. 5, the shorting walls are absent on the first side S1. A structure including the radiating patch RP and the microstrip feed line FL has a mirror symmetry with respect to a plane perpendicular to a surface of the ground plate GP, and passing through a center line intersecting a center point of the microstrip feed line and a center point of the radiating patch (depicted as CP1 and CP2 in FIG. 1D).

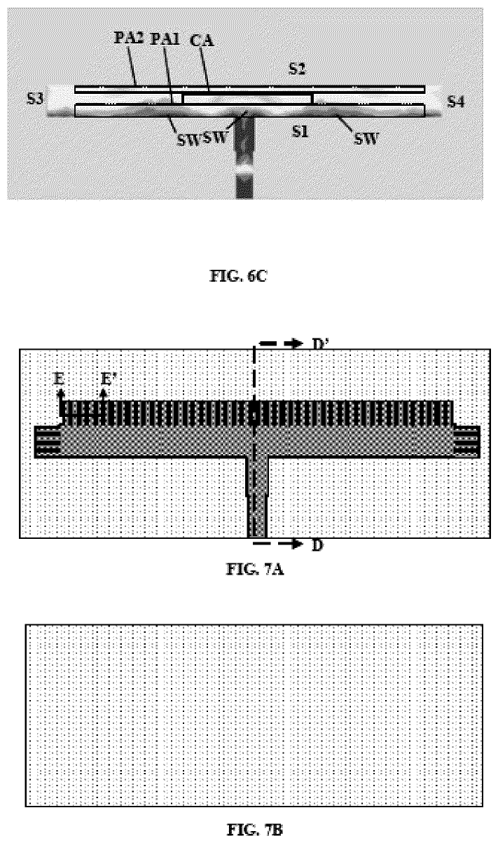

FIG. 6A illustrates an S11 graph of the antenna depicted in FIG. 4A. FIG. 6B illustrates a peak realized gain curve of the antenna depicted in FIG. 4A. FIG. 6C illustrates current distribution in an antenna depicted in FIG. 4A. In one specific example, the antenna has an overall thickness of 0.05 λ₀, wherein λ₀ stands for a wavelength in vacuum of a radiation produced by the antenna. The dielectric layer includes a lossless dielectric material, e.g., the dielectric layer is an air layer. Referring to FIG. 6A, the antenna has a −10 dB impedance bandwidth of 240 MHz (ranging from 3.38 GHz to 3.62 GHZ). Referring to FIG. 6B, the peak value of gain is 11.0 dBi. The bandwidth of the antenna substantially covers the n78 band, which ranges from 3.4 GHz to 3.6 GHz.

FIG. 6C illustrates current distribution in an antenna depicted in FIG. 4A. Referring to FIG. 4D and FIG. 6C, in some embodiments, the gain enhancement structure GES is configured to produce one or more standing waves SW in a peripheral area on the first side S1 of the radiating patch RP due to increased current distribution therein. In some embodiments, the gain enhancement structure GSE is configured to produce increased current distribution in at least a portion of a peripheral area on the first side S1 of the radiating patch RP, relative to current distribution in at least a portion of a central area CA of the radiating patch RP. Optionally, the gain enhancement structure GSE is configured to produce increased current distribution in at least a portion of a peripheral area on the first side S1 of the radiating patch RP, relative to current distribution in at least a portion of a peripheral area on the second side S2 of the radiating patch RP. The radiating patch RP in FIG. 6C has a much lower current on sides having the shorting walls (the second side S2, the third side S3, and the fourth side S4). As compared to the antenna depicted in FIG. 3C, the antenna depicted in FIG. 4A has a lower gain, but the bandwidth of the antenna still covers the n78 band.

In one example depicted in FIG. 4D, a ratio of a width of the second side S2 to a width of the third side S3 or to a width of the fourth side S4 is 12.6:1; a ratio of a width of the first side S1 to a width of the third side S3 or to a width of the fourth side S4 is 12.6:1; the width of the first side S1 or the second side S2 is 290 mm; and the width of the third side S3 or the fourth side S4 is 23 mm.

FIG. 7A is a plan view of an antenna in some embodiments according to the present disclosure. FIG. 7B illustrates the structure of a ground plate in an antenna depicted in FIG. 7A. FIG. 7C illustrates the structure of a dielectric layer in an antenna depicted in FIG. 7A. FIG. 7D illustrates the structure of a microstrip feed line and a radiating patch in an antenna depicted in FIG. 7A. Referring to FIG. 7A to FIG. 7D, the antenna in some embodiments includes a ground plate GP, a dielectric layer DL on the ground plate GP; and a radiating patch RP and a microstrip feed line FL on a side of the dielectric layer DL away from the ground plate GP. The gain enhancement structure GES includes a plurality of teeth connected to and extending away from the second side S2, the third side S3, and the fourth side S4 of the radiating patch RP, respectively.

FIG. 8 is a cross-sectional view along a E-E′ line in FIG. 7A. In one example depicted in FIG. 7A to FIG. 7D, and FIG. 8, the ratio of the first width w1 to the second width w2 is 2:1; the first width w1 is 4.0 mm; the second width w2 is 2.0 mm; the length h is 17.5 mm; the respective teeth and the respective slit have a rectangular shape; the ratio of a width of the second side S2 to a width of the third side S3 or to a width of the fourth side S4 is 12.6:1; the ratio of a width of the first side S1 to a width of the third side S3 or to a width of the fourth side S4 is 12.6:1; the width of the first side S1 or the second side S2 is 290 mm; the width of the third side S3 or the fourth side S4 is 23 mm; and the ratio of the number of teeth on the second side S2 to the number of teeth on the third side S3 or to the number of teeth on the fourth side S4 is 12:1. In one example, the number of teeth on the second side S2 is 48, the number of teeth on the third side S3 is 4, and the number of teeth on the fourth side S4 is 4.

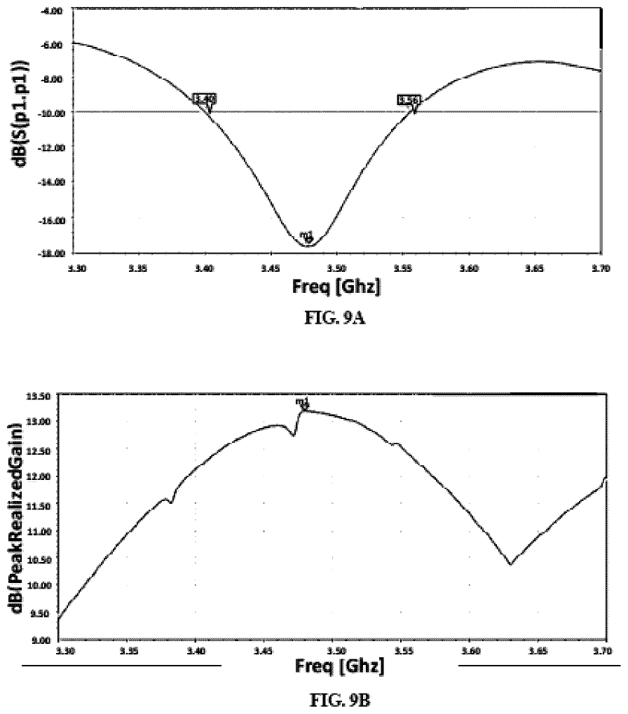

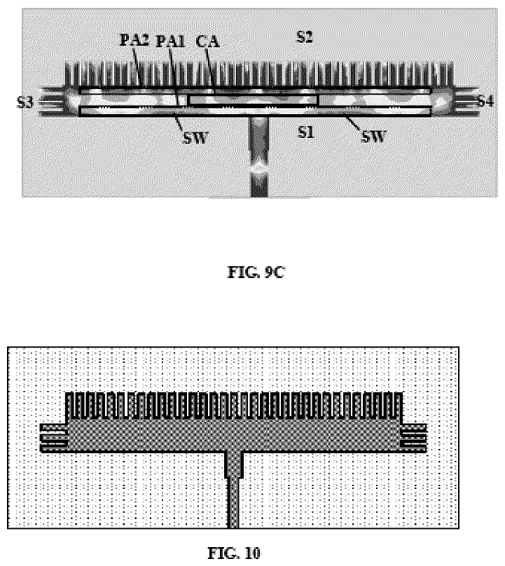

FIG. 9A illustrates an S11 graph of the antenna depicted in FIG. 7A. FIG. 9B illustrates a peak realized gain curve of the antenna depicted in FIG. 7A. FIG. 9C illustrates current distribution in an antenna depicted in FIG. 7A. In one specific example, the antenna has an overall thickness of 0.05 λ₀, wherein λ₀ stands for a wavelength in vacuum of a radiation produced by the antenna. The dielectric layer includes a lossless dielectric material, e.g., the dielectric layer is an air layer. Referring to FIG. 9A, the antenna has a −10 dB impedance bandwidth of 160 MHz (ranging from 3.40 GHz to 3.56 GHZ). Referring to FIG. 9B, the peak value of gain is 13.18 dBi. The bandwidth of the antenna substantially covers the n78 band, which ranges from 3.4 GHz to 3.6 GHz.

As compared to the antenna depicted in FIG. 1A, the ratio of the first width w1 to the second width w2 in the antenna depicted in FIG. 7A increases from 1:1 to 2:1, and the second width w2 decreases by half. As shown in FIG. 9A and FIG. 9B, the gain of the antenna maintains at a same level. In addition, the inventors of the present disclosure discover that the gain of the antenna maintains substantially the same when the first width w1 is maintained in the range of 1 mm to 4 mm.

Referring to FIG. 7D and FIG. 9C, in some embodiments, the gain enhancement structure GES is configured to produce one or more standing waves SW in a peripheral area on the first side S1 of the radiating patch RP due to increased current distribution therein. In some embodiments, the gain enhancement structure GSE is configured to produce increased current distribution in at least a portion of a peripheral area on the first side S1 of the radiating patch RP, relative to current distribution in at least a portion of a central area CA of the radiating patch RP. Moreover, when the gain enhancement structure GSE includes a plurality of teeth, the plurality of teeth are configured to produce increased current distribution in at least a portion of a peripheral area on the first side S1 of the radiating patch and in at least portions of the plurality of teeth, relative to current distribution in at least a portion of a central area CA of the radiating patch RP. Optionally, the gain enhancement structure GSE is configured to produce increased current distribution in at least a portion of a peripheral area on the first side S1 of the radiating patch RP, relative to current distribution in at least a portion of a peripheral area on the second side S2 of the radiating patch RP. The peripheral area on the first side S1 of the radiating patch RP is denoted as PA1 in FIG. 9C, and the peripheral area on the second side S2 of the radiating patch RP is denoted as PA2 in FIG. 9C. As shown in FIG. 7D and FIG. 9C, the presence of the gain enhancement structure GSE (e.g., the plurality of teeth) changes current distribution in the radiating patch RP, significantly enhancing radiation intensity of the radiating patch RP, and the gain of the antenna.

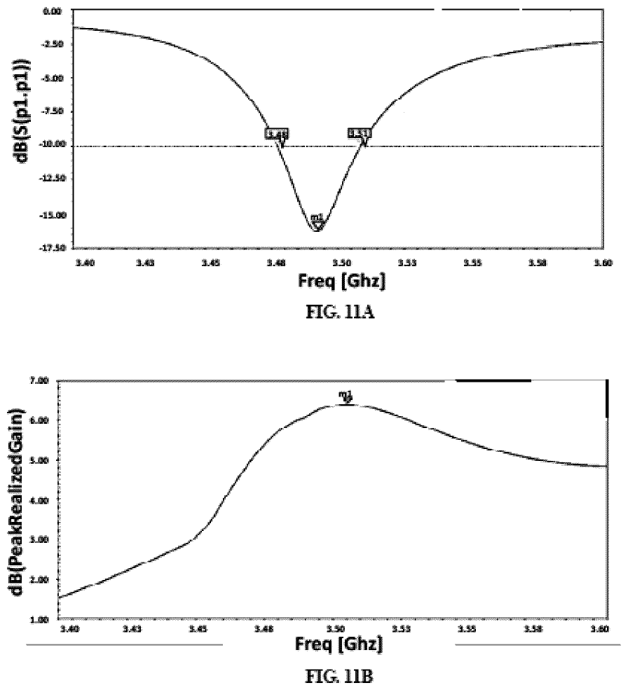

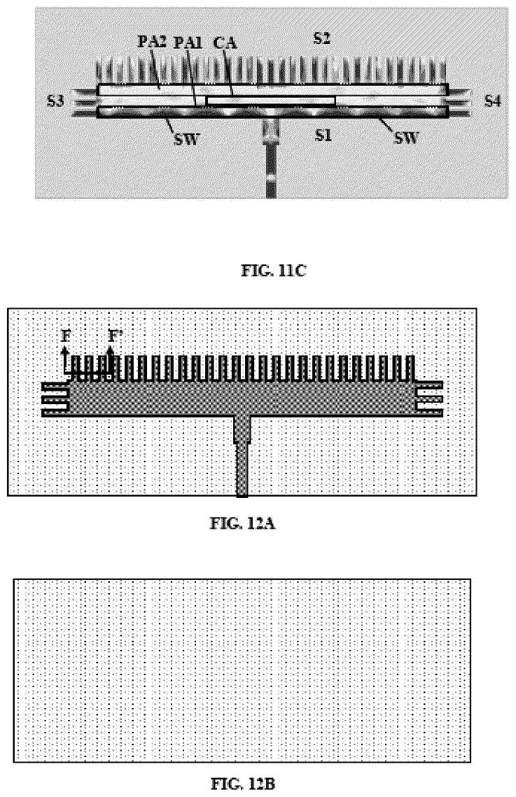

FIG. 10 is a plan view of an antenna in some embodiments according to the present disclosure. The antenna in FIG. 10 differs from the antenna in FIG. 1A in that the dielectric layer DL in FIG. 10 includes a lossy dielectric material whereas the dielectric layer DL in FIG. 1A includes air. FIG. 11A illustrates an S11 graph of the antenna depicted in FIG. 10. FIG. 11B illustrates a peak realized gain curve of the antenna depicted in FIG. 10. Referring to FIG. 11A, the antenna has a −10 dB impedance bandwidth of 30 MHz (ranging from 3.48 GHz to 3.51 GHZ). Referring to FIG. 3B, the peak value of gain is 6.38 dBi. The bandwidth of the antenna is still within the n78 band. As compared to the antenna depicted in FIG. 1A, the bandwidth of the antenna depicted in FIG. 10 is relatively narrow due to the use of the lossy dielectric material in the dielectric layer DL. The gain of the antenna in FIG. 10 decreases approximately by half as compared to the antenna depicted in FIG. 1A.

FIG. 11C illustrates current distribution in an antenna depicted in FIG. 10. Referring to FIG. 11C, even when a lossy dielectric material is used in the dielectric layer DL, the gain enhancement structure GES still produces one or more standing waves SW in a peripheral area on the first side S1 of the radiating patch RP due to increased current distribution therein. Moreover, increased current distribution is observed in at least a portion of a peripheral area on the first side S1 of the radiating patch and in at least portions of the plurality of teeth, relative to current distribution in at least a portion of a central area CA of the radiating patch RP.

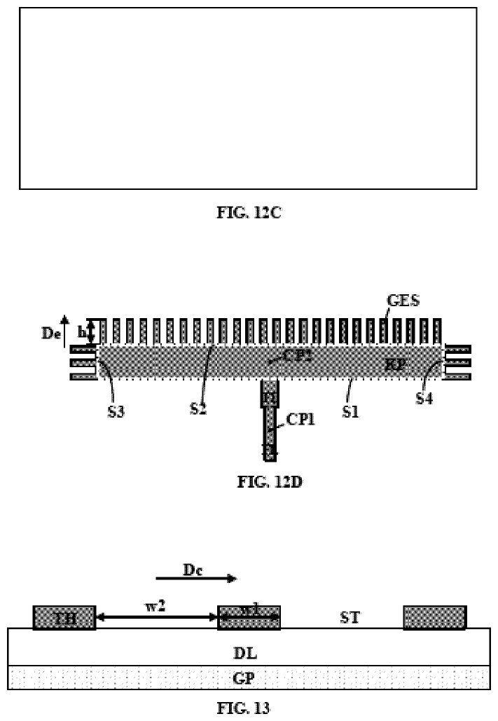

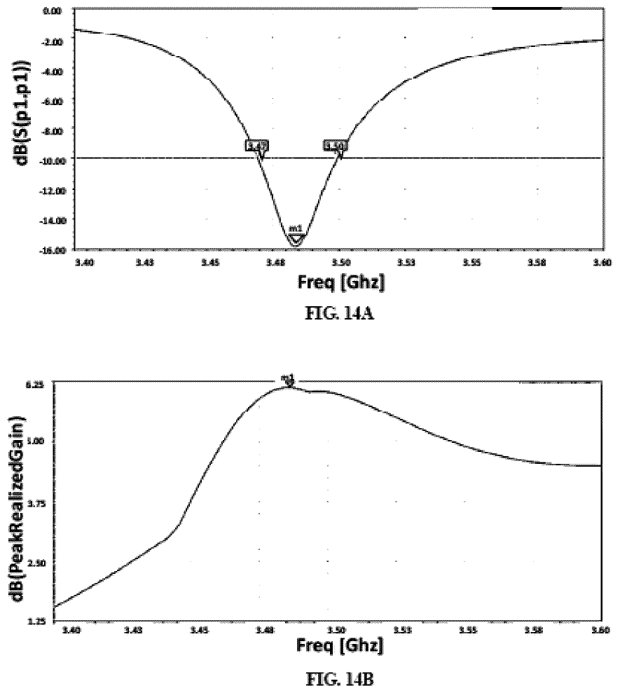

FIG. 12A is a plan view of an antenna in some embodiments according to the present disclosure. FIG. 12B illustrates the structure of a ground plate in an antenna depicted in FIG. 12A. FIG. 12C illustrates the structure of a dielectric layer in an antenna depicted in FIG. 12A. FIG. 12D illustrates the structure of a microstrip feed line and a radiating patch in an antenna depicted in FIG. 12A. Referring to FIG. 12A to FIG. 12D, the antenna in some embodiments includes a ground plate GP, a dielectric layer DL on the ground plate GP; and a radiating patch RP and a microstrip feed line FL on a side of the dielectric layer DL away from the ground plate GP. The gain enhancement structure GES includes a plurality of teeth connected to and extending away from the second side S2, the third side S3, and the fourth side S4 of the radiating patch RP, respectively.

FIG. 13 is a cross-sectional view along an F-F′ line in FIG. 12A. In one example depicted in FIG. 12A to FIG. 12D, and FIG. 13, the ratio of the first width w1 to the second width w2 is 2:3; the first width w1 is 4.0 mm; the second width w2 is 6.0 mm; the length h is 19.0 mm; the respective teeth and the respective slit have a rectangular shape; the ratio of a width of the second side S2 to a width of the third side S3 or to a width of the fourth side S4 is 10.4:1; the ratio of a width of the first side S1 to a width of the third side S3 or to a width of the fourth side S4 is 10.4:1; the width of the first side S1 or the second side S2 is 260 mm; the width of the third side S3 or the fourth side S4 is 25 mm; and the ratio of the number of teeth on the second side S2 to the number of teeth on the third side S3 or to the number of teeth on the fourth side S4 is 26:3. In one example, the number of teeth on the second side S2 is 26, the number of teeth on the third side S3 is 3, and the number of teeth on the fourth side S4 is 3.

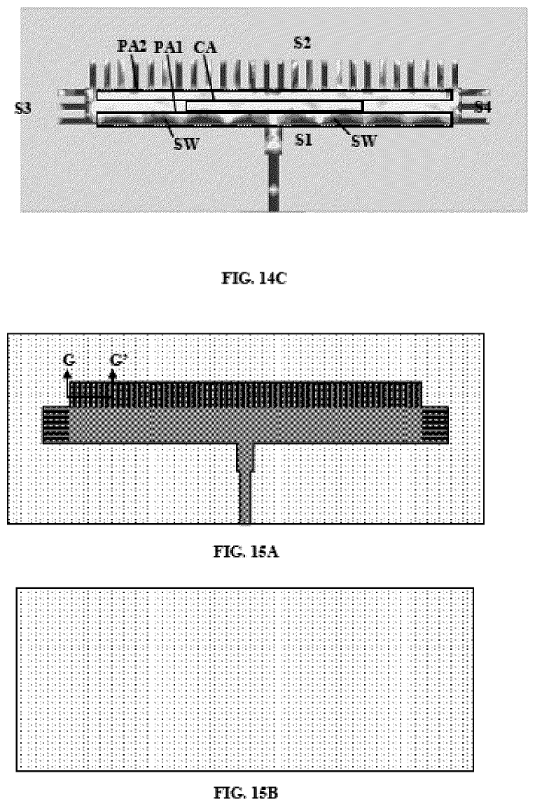

FIG. 14A illustrates an S11 graph of the antenna depicted in FIG. 12A. FIG. 14B illustrates a peak realized gain curve of the antenna depicted in FIG. 12A. In one specific example, the antenna has an overall thickness of 0.05 λ₀, wherein λ₀ stands for a wavelength in vacuum of a radiation produced by the antenna. The dielectric layer includes a lossy dielectric material. Referring to FIG. 14A, the antenna has a −10 dB impedance bandwidth of 30 MHz (ranging from 3.47 GHz to 3.50 GHZ). Referring to FIG. 14B, the peak value of gain is 6.13 dBi. The bandwidth of the antenna is still within the n78 band.

As compared to the antenna depicted in FIG. 10, the ratio of the first width w1 to the second width w2 in the antenna depicted in FIG. 12A decreases from 1:1 to 2:3, and the second width w2 increases by three times. As shown in FIG. 14A and FIG. 14B, the gain of the antenna maintains at a same level as compared to the antenna depicted in FIG. 10.

As compared to the antenna depicted in FIG. 1A, the bandwidth of the antenna depicted in FIG. 12A is relatively narrow due to the use of the lossy dielectric material in the dielectric layer DL. The gain of the antenna depicted in FIG. 12A decreases approximately by half as compared to the antenna depicted in FIG. 1A.

FIG. 14C illustrates current distribution in an antenna depicted in FIG. 12A.

Referring to FIG. 14C, even when a lossy dielectric material is used in the dielectric layer DL, the gain enhancement structure GES still produces one or more standing waves SW in a peripheral area on the first side S1 of the radiating patch RP due to increased current distribution therein. Moreover, increased current distribution is observed in at least a portion of a peripheral area on the first side S1 of the radiating patch and in at least portions of the plurality of teeth, relative to current distribution in at least a portion of a central area CA of the radiating patch RP.

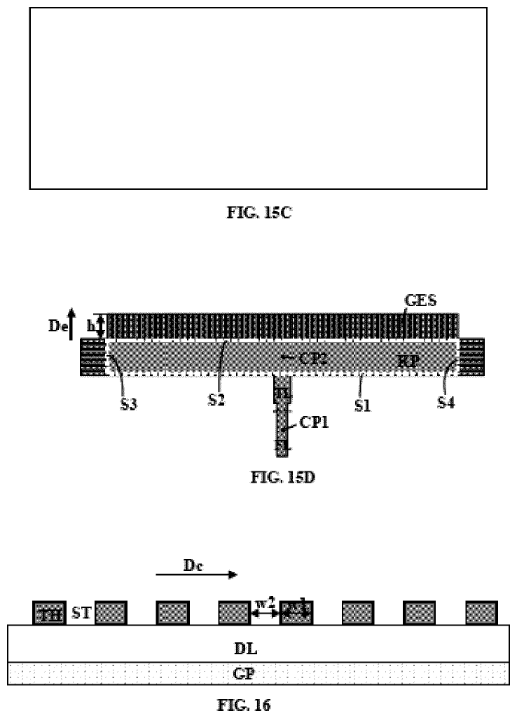

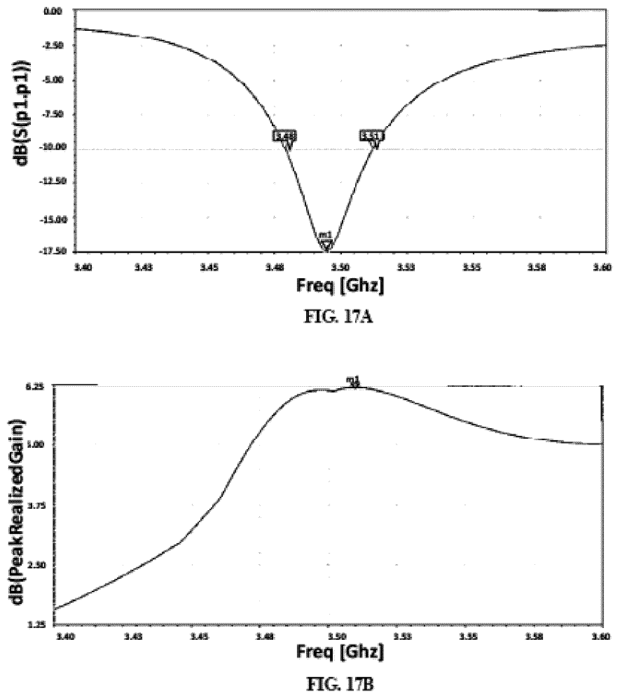

FIG. 15A is a plan view of an antenna in some embodiments according to the present disclosure. FIG. 15B illustrates the structure of a ground plate in an antenna depicted in FIG. 15A. FIG. 15C illustrates the structure of a dielectric layer in an antenna depicted in FIG. 15A. FIG. 15D illustrates the structure of a microstrip feed line and a radiating patch in an antenna depicted in FIG. 15A. Referring to FIG. 15A to FIG. 15D, the antenna in some embodiments includes a ground plate GP, a dielectric layer DL on the ground plate GP; and a radiating patch RP and a microstrip feed line FL on a side of the dielectric layer DL away from the ground plate GP. The gain enhancement structure GES includes a plurality of teeth connected to and extending away from the second side S2, the third side S3, and the fourth side S4 of the radiating patch RP, respectively.

FIG. 16 is a cross-sectional view along a G-G′ line in FIG. 15A. In one example depicted in FIG. 15A to FIG. 15D, and FIG. 16, the ratio of the first width w1 to the second width w2 is 1:1; the first width w1 is 2.0 mm; the second width w2 is 2.0 mm; the length h is 19.0 mm; the respective teeth and the respective slit have a rectangular shape; the ratio of a width of the second side S2 to a width of the third side S3 or to a width of the fourth side S4 is 10.4:1; the ratio of a width of the first side S1 to a width of the third side S3 or to a width of the fourth side S4 is 10.4:1; the width of the first side S1 or the second side S2 is 260 mm; the width of the third side S3 or the fourth side S4 is 25 mm; and the ratio of the number of teeth on the second side S2 to the number of teeth on the third side S3 or to the number of teeth on the fourth side S4 is 65:7. In one example, the number of teeth on the second side S2 is 65, the number of teeth on the third side S3 is 7, and the number of teeth on the fourth side S4 is 7.

FIG. 17A illustrates an S11 graph of the antenna depicted in FIG. 15A. FIG. 17B illustrates a peak realized gain curve of the antenna depicted in FIG. 15A. In one specific example, the antenna has an overall thickness of 0.05 λ₀, wherein λ₀ stands for a wavelength in vacuum of a radiation produced by the antenna. The dielectric layer includes a lossy dielectric material. Referring to FIG. 17A, the antenna has a −10 dB impedance bandwidth of 30 MHz (ranging from 3.48 GHz to 3.51 GHZ). Referring to FIG. 17B, the peak value of gain is 6.21 dBi. The bandwidth of the antenna is still within the n78 band.

As compared to the antenna depicted in FIG. 10, the ratio of the first width w1 to the second width w2 in the antenna depicted in FIG. 15A remains unchanged, the first width w1 decreases by half, and the second width w2 decreases by half. As shown in FIG. 17A and FIG. 17B, the gain of the antenna maintains at a same level as compared to the antenna depicted in FIG. 10.

As compared to the antenna depicted in FIG. 1A, the bandwidth of the antenna depicted in FIG. 15A is relatively narrow due to the use of the lossy dielectric material in the dielectric layer DL. The gain of the antenna depicted in FIG. 15A decreases approximately by half as compared to the antenna depicted in FIG. 1A.

FIG. 17C illustrates current distribution in an antenna depicted in FIG. 15A. Referring to FIG. 17C, even when a lossy dielectric material is used in the dielectric layer DL, the gain enhancement structure GES still produces one or more standing waves SW in a peripheral area on the first side S1 of the radiating patch RP due to increased current distribution therein. Moreover, increased current distribution is observed in at least a portion of a peripheral area on the first side S1 of the radiating patch and in at least portions of the plurality of teeth, relative to current distribution in at least a portion of a central area CA of the radiating patch RP.

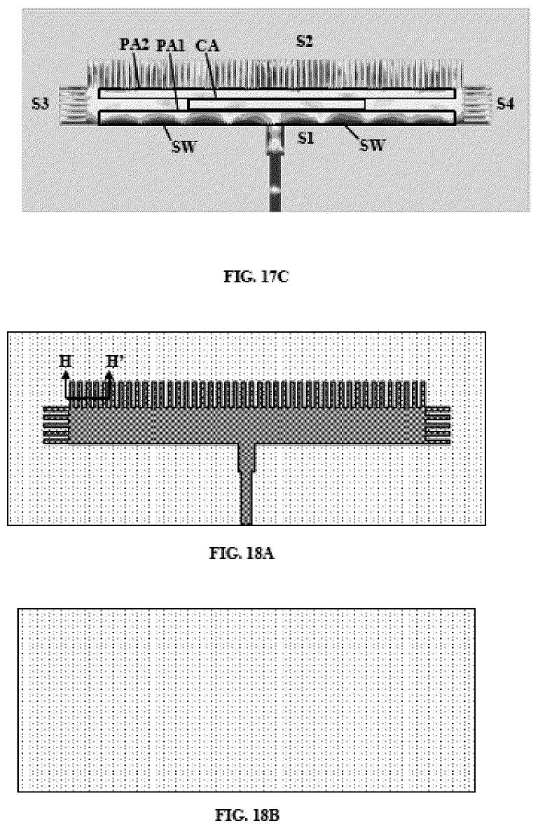

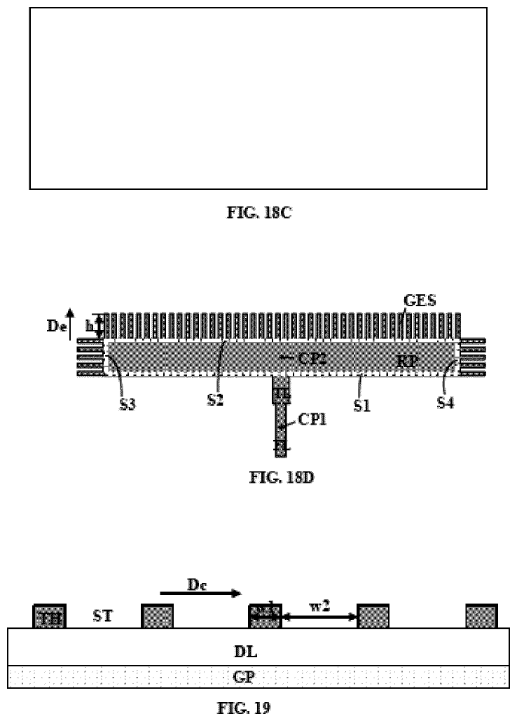

FIG. 18A is a plan view of an antenna in some embodiments according to the present disclosure. FIG. 18B illustrates the structure of a ground plate in an antenna depicted in FIG. 18A. FIG. 18C illustrates the structure of a dielectric layer in an antenna depicted in FIG. 18A. FIG. 18D illustrates the structure of a microstrip feed line and a radiating patch in an antenna depicted in FIG. 18A. Referring to FIG. 18A to FIG. 18D, the antenna in some embodiments includes a ground plate GP, a dielectric layer DL on the ground plate GP; and a radiating patch RP and a microstrip feed line FL on a side of the dielectric layer DL away from the ground plate GP. The gain enhancement structure GES includes a plurality of teeth connected to and extending away from the second side S2, the third side S3, and the fourth side S4 of the radiating patch RP, respectively.

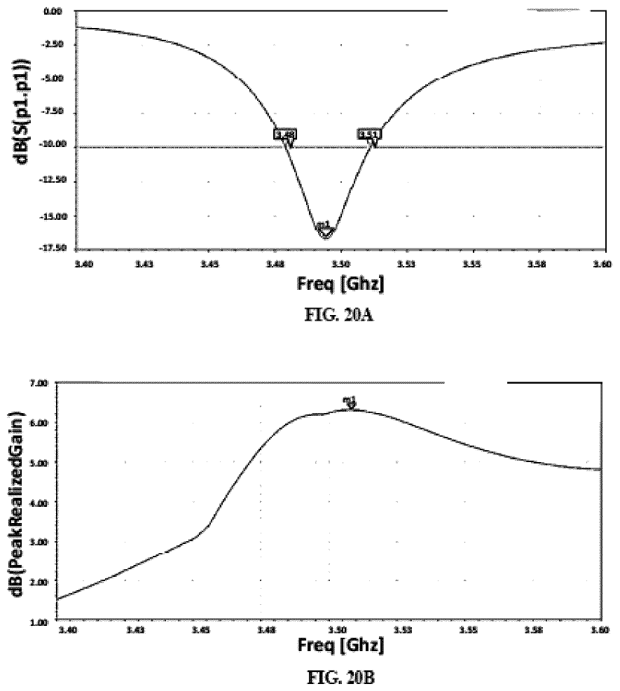

FIG. 19 is a cross-sectional view along an H-H′ line in FIG. 18A. In one example depicted in FIG. 15A to FIG. 15D, and FIG. 16, the ratio of the first width w1 to the second width w2 is 1:2; the first width w1 is 2.0 mm; the second width w2 is 4.0 mm; the length h is 19.0 mm; the respective teeth and the respective slit have a rectangular shape; the ratio of a width of the second side S2 to a width of the third side S3 or to a width of the fourth side S4 is 10.4:1; the ratio of a width of the first side S1 to a width of the third side S3 or to a width of the fourth side S4 is 10.4:1; the width of the first side S1 or the second side S2 is 260 mm; the width of the third side S3 or the fourth side S4 is 25 mm; and the ratio of the number of teeth on the second side S2 to the number of teeth on the third side S3 or to the number of teeth on the fourth side S4 is 44:5. In one example, the number of teeth on the second side S2 is 44, the number of teeth on the third side S3 is 5, and the number of teeth on the fourth side S4 is 5.

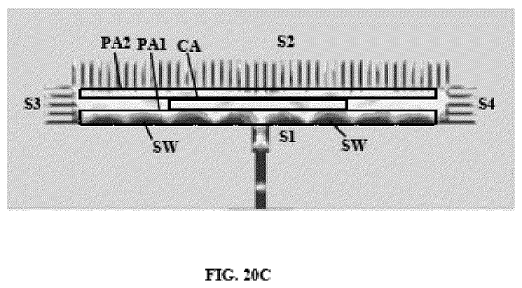

FIG. 20A illustrates an S11 graph of the antenna depicted in FIG. 18A. FIG. 20B illustrates a peak realized gain curve of the antenna depicted in FIG. 18A. In one specific example, the antenna has an overall thickness of 0.05 λ₀, wherein λ₀ stands for a wavelength in vacuum of a radiation produced by the antenna. The dielectric layer includes a lossy dielectric material. Referring to FIG. 17A, the antenna has a −10 dB impedance bandwidth of 30 MHz (ranging from 3.48 GHz to 3.51 GHZ). Referring to FIG. 17B, the peak value of gain is 6.31 dBi. The bandwidth of the antenna is still within the n78 band.

As compared to the antenna depicted in FIG. 15A, the ratio of the first width w1 to the second width w2 in the antenna depicted in FIG. 18A decreases by half, the first width w1 remains unchanged, and the second width w2 doubles. As shown in FIG. 19A and FIG. 19B, the gain of the antenna maintains at a same level as compared to the antenna in FIG. 15A.

As compared to the antenna in FIG. 1A, the bandwidth of the antenna depicted in FIG. 18A is relatively narrow due to the use of the lossy dielectric material in the dielectric layer DL. The gain of the antenna in FIG. 18A decreases approximately by half as compared to the antenna in FIG. 1A.

FIG. 20C illustrates current distribution in an antenna depicted in FIG. 18A.

Referring to FIG. 20C, even when a lossy dielectric material is used in the dielectric layer DL, the gain enhancement structure GES still produces one or more standing waves SW in a peripheral area on the first side S1 of the radiating patch RP due to increased current distribution therein. Moreover, increased current distribution is observed in at least a portion of a peripheral area on the first side S1 of the radiating patch and in at least portions of the plurality of teeth, relative to current distribution in at least a portion of a central area CA of the radiating patch RP.

In some embodiments, the antenna further includes impedance transformation line TL configured to perform impedance matching. The impedance transformation line TL connects the microstrip feed line FL to the radiating patch RP.

In some embodiments, and referring to FIG. 2A, the antenna further includes a radio-frequency connector SMA configured to receive an external radio-frequency signal. The radio-frequency connector SMA is connected to the microstrip feed line FL, and coupled to the radiating patch RP through the microstrip feed line FL.

In some embodiments, and referring to FIG. 1A, FIG. 4A, FIG. 7A, FIG. 10, FIG. 12A, FIG. 15A, and FIG. 18A, an orthographic projection of the ground plate GP on the dielectric layer DL covers an orthographic projection of a structure including the microstrip feed line FL and the radiating patch RP on the dielectric layer DL. Optionally, the orthographic projection of the ground plate GP on the dielectric layer DL covers an orthographic projection of a structure including the microstrip feed line FL, the radiating patch RP, and the gain enhancement structure GES on the dielectric layer DL. Optionally, the orthographic projection of the ground plate GP on the dielectric layer DL covers an orthographic projection of a structure including the microstrip feed line FL, the radiating patch RP, the gain enhancement structure GES, and the impedance transformation line TL on the dielectric layer DL.

In some embodiments, and referring to FIG. 1A, FIG. 4A, FIG. 7A, FIG. 10, FIG. 12A, FIG. 15A, and FIG. 18A, an orthographic projection of the dielectric layer DL on the ground plate GP covers an orthographic projection of a structure including the microstrip feed line FL and the radiating patch RP on the ground plate GP. Optionally, the orthographic projection of the dielectric layer DL on the ground plate GP covers an orthographic projection of a structure including the microstrip feed line FL, the radiating patch RP, and the gain enhancement structure GES on the ground plate GP. Optionally, the orthographic projection of the dielectric layer DL on the ground plate GP covers an orthographic projection of a structure including the microstrip feed line FL, the radiating patch RP, the gain enhancement structure GES, and the impedance transformation line TL on the ground plate GP.

In some embodiments, and referring to FIG. 1A, FIG. 4A, FIG. 7A, FIG. 10, FIG. 12A, FIG. 15A, and FIG. 18A, a structure including the microstrip feed line FL and the radiating patch RP has a T shape.

In some embodiments, and referring to FIG. 1A, FIG. 4A, FIG. 7A, FIG. 10, FIG. 12A, FIG. 15A, and FIG. 18A, the ground plate GP has a parallelogram shape such as rectangular shape. In one specific example, the parallelogram shape has a length of 350 mm and a width of 140 mm.

In some embodiments, and referring to FIG. 1A, FIG. 4A, FIG. 7A, FIG. 10, FIG. 12A, FIG. 15A, and FIG. 18A, the dielectric layer DL has a parallelogram shape such as rectangular shape. In one specific example, the parallelogram shape has a length of 350 mm and a width of 140 mm.

The dielectric layer DL may be made of various appropriate dielectric materials. In one example, the dielectric layer DL is made of a lossless dielectric material such as air. In another example, the dielectric layer DL is made of a lossy dielectric material. As used herein, a lossless dielectric material is a material for which σωε<1100, a lossy dielectric material is a material for which 100<σωε, wherein σ is the electrical conductivity of medium (material), ∈ is the permittivity of medium, and ω is radian frequency, which is 2πf, where f is the frequency. Example of lossy dielectric materials include certain ceramics. Examples of lossless dielectric materials include air.

In another aspect, the present disclosure provide an electronic apparatus. In some embodiments, the electronic apparatus includes an antenna described herein, and one or more circuits. In one example, the electronic apparatus is a display apparatus. In some embodiments, the display apparatus includes a display panel and an antenna described herein connected to the display panel. Examples of appropriate display apparatuses include, but are not limited to, an electronic paper, a mobile phone, a tablet computer, a television, a monitor, a notebook computer, a digital album, a GPS, etc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An antenna, comprising:
a ground plate;
a dielectric layer on the ground plate; and
a radiating patch and a microstrip feed line on a side of the dielectric layer away from the ground plate;
wherein the radiating patch has a parallelogram shape having a first side connected to the microstrip feed line, a second side opposite to the first side, a third side connecting the first side and the second side, and a fourth side connecting the first side and the second side, the third side being opposite to the fourth side; and
the antenna further comprises a gain enhancement structure on at least one of the second side, the third side, or the fourth side.

2. The antenna of claim 1, wherein the gain enhancement structure is on each of the second side, the third side, and the fourth side.

3. The antenna of claim 1, wherein a structure comprising the radiating patch and the microstrip feed line has a mirror symmetry with respect to a plane perpendicular to a surface of the ground plate, and passing through a center line intersecting a center point of the microstrip feed line and a center point of the radiating patch.

4. The antenna of claim 1, wherein the gain enhancement structure is configured to produce one or more standing waves in a peripheral area on the first side of the radiating patch due to increased current distribution therein.

5. The antenna of claim 1, wherein the gain enhancement structure is configured to produce increased current distribution in at least a portion of a peripheral area on the first side of the radiating patch, relative to current distribution in at least a portion of a central area of the radiating patch.

6. The antenna of claim 1, wherein the gain enhancement structure comprises a plurality of teeth connected to and extending away from the second side, the third side, and the fourth side of the radiating patch, respectively.

7. The antenna of claim 6, wherein, on each of the second side, the third side, and the fourth side of the radiating patch, multiple teeth are spaced apart by multiple slits, respectively;
the multiple teeth are equispaced; and
the multiple slits are equispaced.

8. The antenna of claim 7, wherein a respective teeth of the multiple teeth has a first width along a direction across the multiple teeth and the multiple slits;
a respective slit of the multiple slits has a second width along the direction across the multiple teeth and the multiple slits; and
a ratio of the first width to the second width is in a range of 1:2 to 2:1.

9. The antenna of claim 7, wherein a respective teeth of the multiple teeth has a first width along a direction across the multiple teeth and the multiple slits in a range of 1 mm to 4 mm.

10. The antenna of claim 7, wherein a respective slit of the multiple slits has a second width along a direction across the multiple teeth and the multiple slits in a range of 2 mm to 6 mm.

11. The antenna of claim 6, wherein the plurality of teeth are configured to produce increased current distribution in at least a portion of a peripheral area on the first side of the radiating patch and in at least portions of the plurality of teeth, relative to current distribution in at least a portion of a central area of the radiating patch.

12. The antenna of claim 6, wherein a ratio of a number of teeth on the second side to a number of teeth on the third side or to a number of teeth on the fourth side is in a range of 5:1 to 25:1.

13. The antenna of claim 1, wherein a ratio of a width of the second side to a width of the third side or to a width of the fourth side is in a range of 5:1 to 20:1.

14. The antenna of claim 1, wherein the gain enhancement structure comprises shorting walls connecting the second side, the third side, and the fourth side of the radiating patch respectively to the ground plate.

15. The antenna of claim 1, wherein the dielectric layer comprises air.

16. The antenna of claim 1, wherein the dielectric layer comprises a lossy dielectric material.

17. The antenna of claim 1, further comprising an impedance transformation line configured to perform impedance matching;
wherein the impedance transformation line connects the microstrip feed line to the radiating patch.

18. The antenna of claim 1, wherein the antenna is configured to be a magnetic dipole antenna.

19. The antenna of claim 1, wherein the gain enhancement structure is absent on the first side.

20. An electronic apparatus, comprising the antenna of claim 1.
